(19) United States
(12) Patent Application Publication
(10) Pub. No.: US 2021/0117862 A1
(43) Pub. Date: Apr. 22, 2021

(54) METHOD AND SYSTEM FOR ADOPTING USER LEARNINGS ACROSS VERNACULAR CONTEXTS

(71) Applicant: Affle International Pte. Ltd., Singapore (SG)

(72) Inventors: Anuj Khanna SOHUM, Singapore (SG); Charles Yong Jien FOONG, Singapore (SG); Madhusudana RAMAKRISHNA, Singapore (SG)

(73) Assignee: Affle International Pte. Ltd., Singapore (SG)

(21) Appl. No.: 17/073,284

(22) Filed: Oct. 16, 2020

(30) Foreign Application Priority Data
Oct. 18, 2019 (SG) 10201909739R

(51) Int. Cl. G06N 20/00; G06Q 30/02; G10L 17/26

(52) U.S. Cl. CPC G06N 20/00; G10L 17/26; G06Q 30/0201; G06Q 30/0255

(57) ABSTRACT

The present disclosure provides a method and system to adopt user learnings across vernacular contexts. The system receives a first set of data associated with a plurality of users. The system collects a second set of data associated with the plurality of users. The system fetches a third set of data associated with one or more communication devices of the plurality of users. The system analyzes the first set of data, the second set of data, and the third set of data using one or more machine learning algorithms. The system enables segmentation of the plurality of users in one or more segments based on one or more patterns of a plurality of languages and a plurality of language attributes. The system triggers initialization of one or more personalized marketing campaigns for the one or more segments based on the plurality of languages and the plurality of language attributes.

### TECHNICAL FIELD

The present disclosure relates to the field of advertising technology, and in particular, relates to method and system for adopting user learnings across vernacular contexts.

### INTRODUCTION

Over the past few years, online platforms have become a popular way for individuals to interact online. The online platforms have been used to provide range of services to the individuals on Internet in multiple languages in vernacular contexts across the globe. The range of services are such as marketplaces, search engines, social media, consumer business, financial services, industrial products, home services, legal services, creative services, e-learning services, and the like. We have seen the individuals using native languages, secondary languages, slangs, idioms, jargon, and argot while interacting with the online platforms. The individuals look for contents in every language on the online platform while searching in their own native language. The demand of multi-lingual contents of the online platforms has increased in the past few years. The increasing demand leads to a competitive environment within online platform providers. The online platform providers have to make segments for the individuals accessing the online platforms in the multiple languages across the vernacular contexts for running personalized marketing campaigns in this competitive environment. The online platform providers are seeking effective ways to identify the languages used by the individuals while accessing the contents. In addition, the online platform providers seek to segment the individuals based on the lingual and vernacular parameters. However, the present systems and methods do not allow to identify the affinity of the individuals across the multiple languages. In addition, the present systems and methods do not allow the language detection of the individuals consuming the content on the online platforms. Further, the present systems and methods do not allow to determine the proficiency of the individual in the multiple languages. Furthermore, the present systems and methods do not allow segmentation of the individuals based on the multiple languages across the vernacular contexts. In light of the above stated discussion, there is a need for a system that overcomes the above stated disadvantages.

### SUMMARY

In a first example, there a computer-implemented method is provided. The computer-implemented method to adopt user learnings across vernacular contexts. The computer-implemented method includes a first step to receive a first set of data associated with a plurality of users at a multi-lingual campaigning system with a processor. In addition, the computer-implemented method includes a second step to collect a second set of data associated with the plurality of users at the multi-lingual campaigning system with the processor. Further, the computer-implemented method includes a third step to fetch a third set of data associated with one or more communication devices of the plurality of users at the multi-lingual campaigning system with the processor. Furthermore, the computer-implemented method includes a fourth step to analyze the first set of data, the second set of data, and the third set of data using one or more machine learning algorithms at the multi-lingual campaigning system with the processor. The analysis is performed based on training of a machine learning model. The analysis is performed to identify a plurality of languages across the vernacular contexts of the plurality of users. The analysis is performed to identify a plurality of language attributes of the plurality of languages across the vernacular contexts of the plurality of users. The analysis is performed in real time. Moreover, the computer-implemented method includes a fifth step to enable segmentation of the plurality of users in one or more segments based on one or more patterns of the plurality of languages and the plurality of language attributes. The plurality of users is segmented in the one or more segments in real-time. Also, the computer-implemented method includes a sixth step to trigger initialization of one or more personalized marketing campaigns for the one or more segments based on the plurality of languages and the plurality of language attributes across the vernacular contexts of the plurality of users. The one or more personalized marketing campaigns are initiated based on the one or more patterns of the one or more segments. The one or more personalized marketing campaigns are initiated in real-time.

In an embodiment of the present disclosure, the first set of data includes name data, age data, e-mail identity data, contact number data, gender data, demographic data, relationship status data, native language data, and native place data. In addition, the first set of data includes Geo-IP data, real-time geographical location data, past geographical location data, profession data, hobbies data, and interests data.

In an embodiment of the present disclosure, the second set of data corresponds to audio data of the plurality of users. In addition, the second set of data is collected from a set of audio sensors. Further, the second set of data includes recorded speech data, real-time speech data, past voice command data, and real-time voice command data.

In an embodiment of the present disclosure, the third set of data includes past typing data, real-time typing data, and primary language preference data of the one or more communication devices. In addition, the third set of data includes secondary language preference data of the one or more communication devices, browser language data, application language data, installed keyboard data and speech language data.

In an embodiment of the present disclosure, the computer-implemented method creates a vernacular profile of each of the plurality of users based on the analysis of the first set of data, the second set of data, and the third set of data using the one or more machine learning algorithms. In addition, the plurality of users is segmented in the one or more segments based on the vernacular profile and the one or more patterns.

In an embodiment of the present disclosure, the plurality of language attributes includes language proficiency in the plurality of languages across the vernacular contexts of each of the plurality of users, and a regional dialect across the vernacular contexts of each of the plurality of users. In addition, the plurality of language attributes includes an accent associated with each of the plurality of users, frequency of the audio data, and wavelength of the audio data. Further, the plurality of language attributes includes amplitude of the audio data, pitch of the audio data, tone of the audio data, intensity of the audio data, speed of the audio data, and tempo of the audio data.

In an embodiment of the present disclosure, the computer-implemented method detects the accent associated with each of the plurality of users based on the analysis performed on the second set of data using the one or more machine learning algorithms.

In an embodiment of the present disclosure, the computer-implemented method dynamically displays one or more advertisements associated with the one or more personalized marketing campaigns for the one or more segments in real-time. In addition, the one or more advertisements are displayed to each of the plurality of users on the one or more communication devices based on the one or more patterns, and the vernacular profile. Further, each of the one or more advertisements adapts a plurality of characteristics according to the vernacular profile, the plurality of languages, and the plurality of language attributes. Furthermore, the plurality of characteristics includes the accent of audio of the one or more advertisements, colors used in the one or more advertisements, and costumes utilized in the one or more advertisements. Moreover, the plurality of characteristics includes phrases utilized in the one or more advertisements, brand ambassador of the one or more advertisements, and theme of the one or more advertisements.

In an embodiment of the present disclosure, the computer-implemented method dynamically modulates the audio of the one or more advertisements associated with the one or more personalized marketing campaigns based on the accent of each of the plurality of users.

In a second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of the instructions causes the one or more processors to perform a method to adopt the user learnings across the vernacular contexts. The method includes a first step to receive the first set of data associated with the plurality of users at the multi-lingual campaigning system. In addition, the method includes a second step to collect the second set of data associated with the plurality of users at the multi-lingual campaigning system. Further, the method includes a third step to fetch the third set of data associated with the one or more communication devices of the plurality of users at the multi-lingual campaigning system. Furthermore, the method includes a fourth step to analyze the first set of data, the second set of data, and the third set of data using the one or more machine learning algorithms at the multi-lingual campaigning system. The analysis is performed based on training of the machine learning model. The analysis is performed to identify the plurality of languages across the vernacular contexts of the plurality of users. The analysis is performed to identify the plurality of language attributes of the plurality of languages across the vernacular contexts of the plurality of users. The analysis is performed in real time. Moreover, the method includes a fifth step to enable segmentation of the plurality of users in the one or more segments based on the one or more patterns of the plurality of languages and the plurality of language attributes. The plurality of users is segmented in the one or more segments in real-time. Also, the method includes a sixth step to trigger initialization of the one or more personalized marketing campaigns for the one or more segments based on the plurality of languages and the plurality of language attributes across the vernacular contexts of the plurality of users. The one or more personalized marketing campaigns are initiated based on the one or more patterns of the one or more segments. The one or more personalized marketing campaigns are initiated in real-time.

In a third example, a non-transitory computer readable medium is provided. The non-transitory computer readable medium encodes computer executable instructions that, when executed by at least one processor, performs a method to adopt the user learnings across the vernacular contexts. The method includes a first step to receive the first set of data associated with the plurality of users. In addition, the method includes a second step to collect the second set of data associated with the plurality of users. Further, the method includes a third step to fetch the third set of data associated with the one or more communication devices of the plurality of users. Furthermore, the method includes a fourth step to analyze the first set of data, the second set of data, and the third set of data using the one or more machine learning algorithms. The analysis is performed based on training of the machine learning model. The analysis is performed to identify the plurality of languages across the vernacular contexts of the plurality of users. The analysis is performed to identify the plurality of language attributes of the plurality of languages across the vernacular contexts of the plurality of users. The analysis is performed in real time. Moreover, the method includes a fifth step to enable segmentation of the plurality of users in the one or more segments based on the one or more patterns of the plurality of languages and the plurality of language attributes. The plurality of users is segmented in the one or more segments in real-time. Also, the method includes a sixth step to trigger initialization of the one or more personalized marketing campaigns for the one or more segments based on the plurality of languages and the plurality of language attributes across the vernacular contexts of the plurality of users. The one or more personalized marketing campaigns are initiated based on the one or more patterns of the one or more segments. The one or more personalized marketing campaigns are initiated in real-time.

### BRIEF DESCRIPTION OF THE DRAWINGS

Having thus described the invention in general terms, reference will now be made to the accompanying figures, wherein:

FIG. 1 illustrates an interactive computing environment for adopting user learnings across vernacular contexts, in accordance with various embodiments of the present disclosure;

FIGS. 2A and 2B illustrate a flowchart of a method for adopting the user learnings across the vernacular contexts, in accordance with various embodiments of the present disclosure; and

FIG. 3 illustrates a block diagram of a computing device, in accordance with various embodiments of the present invention.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced items.

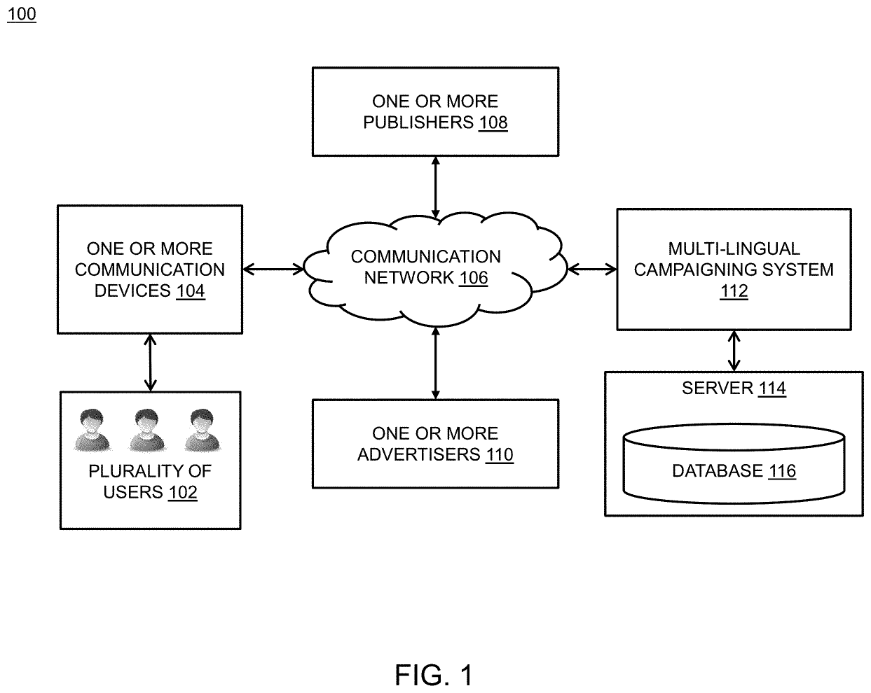

FIG. 1 illustrates an interactive computing environment 100 for adopting user learnings across vernacular contexts, in accordance with various embodiments of the present invention. The interactive computing environment 100 includes a plurality of users 102, one or more communication devices 104, a communication network 106, and one or more publishers 108. In addition, the interactive computing environment 100 includes one or more advertisers 110, a multi-lingual campaigning system 112, a server 114, and a database 116.

The interactive computing environment 100 includes the plurality of users 102. In addition, the plurality of users 102 may be any person or individual accessing the one or more communication devices 104 using a plurality of languages across the vernacular contexts. The plurality of languages includes Malay, English, Japanese, Spanish, German, French, Hindi, Mandarin, Russian, Arabic, and the like. Further, the vernacular contexts include native spoken language, jargons, slangs, idioms, argot and the like. In an embodiment of the present disclosure, the plurality of users 102 is any person who accesses one or more online platforms. In addition, the plurality of users 102 is any person who watches one or more advertisements while accessing the one or more online platforms.

In an embodiment of the present disclosure, the plurality of users 102 is an owner of the one or more communication devices 104. In another embodiment of the present disclosure, the plurality of users 102 is not the owner of the one or more communication devices 104. In an embodiment of the present disclosure, the plurality of users 102 accesses the one or more communication devices 104 at home. In another embodiment of the present disclosure, the plurality of users 102 accesses the one or more communication devices 104 at a cafe. In yet another embodiment of the present disclosure, the plurality of users 102 accesses the one or more communication devices 104 in an office. In an example, a user U1 accesses a smartphone S1 while sitting in a living room. In another example, a user U2 accesses a laptop L1 while travelling from one place to another. In yet another example, a user U3 accesses a desktop computer D1 while working in the office.

The plurality of users 102 corresponds to any number of person or individual associated with the multi-lingual campaigning system 112. In addition, the multi-lingual campaigning system 112 registers each of the plurality of users 102 using the plurality of languages across the vernacular contexts. Further, the multi-lingual campaigning system 112 receives a first set of data associated with the plurality of users 102. Furthermore, the first set of data includes name data, age data, e-mail identity data, contact number data, gender data, demographic data, relationship status data, native language data, and native place data. Moreover, the first set of data includes Geo-IP data, real-time geographical location data, past geographical location data, profession data, hobbies data, interests data, and the like. The first set of data is received from the plurality of users 102. The multi-lingual campaigning system 112 creates a unique profile of each of the plurality of users 102. The multi-lingual campaigning system 112 stores data of each of the plurality of users 102 in corresponding unique profile of each of the plurality of users 102.

The plurality of users 102 accesses the one or more online platforms through the one or more communication devices 104. The one or more communication devices 104 are associated with the plurality of users 102. In addition, the multi-lingual campaigning system 112 receives the first set of data associated with the plurality of users 102. The first set of data corresponds to personal information of the plurality of users 102. In an embodiment of the present disclosure, the first set of data is received from one or more online platform database, one or more communication device database, and third-party database. In another embodiment of the present disclosure, the first set of data is received from the plurality of users 102. In an example, a user U1 may provide his or her name, profile picture, city of residence, contact information, birth date, gender, marital status, employment, educational background, interests, and other demographic information.

In general, each of online platforms is a computing platform which enables various individuals to obtain, upload and access valuable resources or services. The one or more online platforms include a plurality of contents. In an embodiment of the present disclosure, the plurality of contents includes but may not be limited to a plurality of OTT media contents, a plurality of products, a plurality of financial services, and one or more social media contents. In another embodiment of the present disclosure, the plurality of contents includes but may not be limited to a plurality of health services, a plurality of educational services, a plurality of real estate services, and a plurality of travel services. However, the plurality of contents is not limited to the above-mentioned contents.

In an embodiment of the present disclosure, the one or more online platforms correspond to android operating system compatible application. In another embodiment of the present disclosure, the one or more online platforms correspond to windows operating system compatible applications. In yet another embodiment of the present disclosure, the one or more online platforms correspond to iPhone operating system compatible applications. In yet another embodiment of the present disclosure, the one or more online platforms correspond to mac operating system compatible applications. In yet another embodiment of the present disclosure, the one or more online platforms correspond to webpages. However, the one or more online platforms are not limited to the above-mentioned online platforms.

In an example, the one or more online platforms include an over-the top media platform, an e-commerce platform, a fintech platform, a social media platform, and a health platform. In addition, the one or more online platforms include an educational platform, a real estate and housing platform, and a travel platform. However, the one or more online platforms are not limited to the above-mentioned online platforms.

The interactive computing environment 100 includes the one or more communication devices 104. The plurality of users 102 is connected with the interactive computing environment 100 through the one or more communication devices 104. In an embodiment of the present disclosure, the one or more communication devices 104 facilitate access to the one or more online platforms in the plurality of languages using the vernacular contexts. In addition, the one or more online platforms include a plurality of contents in the plurality of languages across the vernacular contexts. Further, the one or more communication devices 104 are associated with the communication network 106. In an embodiment of the present disclosure, the one or more communication devices 104 are associated with the one or more publishers 108 and the one or more advertisers 110 through the communication network 106.

In an embodiment of the present disclosure, each of the one or more communication devices 104 is a portable communication device. The portable communication device includes but may not be limited to a laptop, a smartphone, a tablet, and a smart watch. In an example, the smartphone may be an iOS-based smartphone, an android-based smartphone, a windows-based smartphone and the like. In another embodiment of the present disclosure, each of the one or more communication devices 104 is a fixed communication device. The fixed communication device includes but may not be limited to a desktop, a workstation, a smart TV and a mainframe computer. In an embodiment of the present disclosure, the one or more communication devices 104 are currently in the switched-on state. The one or more communication devices 104 are any type of devices having an active internet. In addition, each of the plurality of users 102 accesses corresponding communication device of the one or more communication devices 104 in real-time.

In an embodiment of the present disclosure, the one or more communication devices 104 perform computing operations based on a suitable operating system installed inside the one or more communication devices 104. In general, the operating system is system software that manages computer hardware and software resources and provide common services for computer programs. In addition, the operating system acts as an interface for software installed inside the one or more communication devices 104 to interact with hardware components of the one or more communication devices 104. In an embodiment of the present disclosure, each of the one or more communication devices 104 perform computing operations based on any suitable operating system designed for the portable communication device. In an example, the operating system installed inside the one or more communication devices 104 is a mobile operating system. Further, the mobile operating system includes but may not be limited to windows operating system, android operating system, iOS operating system, Symbian operating system, BADA operating system from Samsung Electronics and BlackBerry operating system, and Sailfish. However, the operating system is not limited to above mentioned operating systems. In an embodiment of the present disclosure, the one or more communication devices 104 operate on any version of particular operating system corresponding to above mentioned operating systems.

In another embodiment of the present disclosure, the one or more communication devices 104 perform computing operations based on any suitable operating system designed for fixed communication device. In an example, the operating system installed inside the one or more communication devices 104 is windows. In another example, the operating system installed inside the one or more communication devices 104 is Mac. In yet another example, the operating system installed inside the one or more communication devices 104 is Linux based operating system. In yet another example, the operating system installed inside the one or more communication devices 104 is Chrome OS. In yet another example, the operating system installed inside the one or more communication devices 104 may be one of UNIX, Kali Linux, and the like. However, the operating system is not limited to above mentioned operating systems.

In an embodiment of the present disclosure, the one or more communication devices 104 operate on any version of windows operating system. In another embodiment of the present disclosure, the one or more communication devices 104 operate on any version of Mac operating system. In yet another embodiment of the present disclosure, the one or more communication devices 104 operate on any version of Linux operating system. In yet another embodiment of the present disclosure, the one or more communication devices 104 operate on any version of Chrome OS. In yet another embodiment of the present disclosure, the one or more communication devices 104 operate on any version of particular operating system corresponding to above mentioned operating systems.

In an embodiment of the present disclosure, the one or more online platforms are installed on the one or more communication devices 104. The one or more online platforms allows the plurality of users 102 to access the plurality of contents. In another embodiment of the present disclosure, the one or more online platforms are run on a plurality of web browsers installed on the one or more communication devices 104. In an example, the plurality of web browsers include but may not be limited to Opera, Mozilla Firefox, Google Chrome, Internet Explorer, Microsoft Edge, Safari and UC Browser. Further, the plurality of web browsers installed on the one or more communication devices 104 runs on any version of the respective web browser of the above mentioned web browsers. In an example, a user U1 opens an e-commerce application E1 to buy cutlery items. In another example, a user U2 accesses a fintech wepage F2 on Google Chrome for a car loan.

The plurality of users 102 connects with the over-the top media platform on the one or more communication devices 104 to access the plurality of OTT media contents. In an embodiment of the present disclosure, the over-the top media platform is the application installed on the one or more communication devices 104. In another embodiment of the present disclosure, the over-the top media platform is accessed on the one or more communication devices 104 through the plurality of web browsers. In an example, a user U1 watches a sci-fi movie M1 on an OTT platform O1 installed in a form of application on a communication device D1 (let's say a smartphone). In another example, a user U2 watches a stand-up comedy show S2 on an OTT platform O2 on a communication device D2 (let's say a desktop computer) through a web browser W2 (let's say Google Chrome). In yet another example, a user U3 adds an anime A3 to a watch-list W3 on an OTT platform O3 installed on a communication device D3 (let's say a tablet).

The plurality of users 102 connects with the e-commerce platform on the one or more communication devices 104 to access the plurality of products. In an embodiment of the present disclosure, the e-commerce platform is the application installed on the one or more communication devices 104. In another embodiment of the present disclosure, the e-commerce platform is accessed on the one or more communication devices 104 through the plurality of web browsers. In an example, a user U1 surfs various smartwatches S1 on an e-commerce platform E1 installed in a form of application on a communication device D1 (let's say a smartphone). In another example, a user U2 buys a grooming kit G2 on an e-commerce platform E2 on a communication device D2 (let's say a desktop computer) through a web browser W2 (let's say UC Browser). In yet another example, a user U3 adds a musical instrument M3 to a cart on an e-commerce platform E3 installed on a communication device D3 (let's say a tablet).

The plurality of users 102 connects with the fintech platform on the one or more communication devices 104 to access the plurality of financial services. In an embodiment of the present disclosure, the fintech platform is the application installed on the one or more communication devices 104. In another embodiment of the present disclosure, the fintech platform is accessed on the one or more communication devices 104 through the plurality of web browsers. In an example, a user U1 surfs various account opening options O1 on fintech platform F1 installed in a form of application on a communication device D1 (let's say a smartphone). In another example, a user U2 requests for car loan L2 on a fintech platform F2 on a communication device D2 (let's say a desktop computer) through a web browser W2 (let's say Google Chrome). In yet another example, a user U3 buys a credit card C3 on a fintech platform F3 on a communication device D3 (let's say a tablet) through a web browser W3 (let's say Microsoft Edge).

The plurality of users 102 connects with the social media platform on the one or more communication devices 104 to access the one or more social media contents. In an embodiment of the present disclosure, the social media platform is the application installed on the one or more communication devices 104. In another embodiment of the present disclosure, the social media platform is accessed on the one or more communication devices 104 through the plurality of web browsers. In an example, a user U1 surfs various multimedia content C1 (let's say a teaser of a music video) on a social media platform S1 installed in a form of application on a communication device D1 (let's say a smartphone). In another example, a user U2 promotes a handcraft product P2 (let's say a woodcraft vase) on a social media platform S2 on a communication device D2 (let's say a desktop computer) through a web browser W2 (let's say Mozilla Firefox). In yet another example, a user U3 streams live video V3 on a social media platform S3 through a web browser W3 (let's say Opera Browser). In yet another example, a manufacturer of goods, a service provider, and a retailer may join the social media platform S4. The social media platform S4 allows users U4 to be connected to the manufacturer of goods, the service provider, and the retailer.

The plurality of users 102 connects with the health platform on the one or more communication devices 104 to access the plurality of health services. In an embodiment of the present disclosure, the health platform is the application installed on the one or more communication devices 104. In another embodiment of the present disclosure, the health platform is accessed on the one or more communication devices 104 through the plurality of web browsers. In an example, a user U1 surfs various healthcare contents (let's say a tuberculosis medicine) on a health platform H1 installed in a form of application on a communication device D1 (let's say a smartphone). In another example, a user U2 creates a dietary plan on a health platform H2 on a communication device D2 (let's say a desktop computer) through a web browser W2 (let's say Mozilla Firefox). In yet another example, a user U3 buys medicine M3 (let's say diabetes medicines) on a health platform H3 installed on a communication device D3 (let's say a tablet).

The plurality of users 102 connects with the education platform on the one or more communication devices 104 to access the plurality of educational services. In an embodiment of the present disclosure, the education platform is the application installed on the one or more communication devices 104. In another embodiment of the present disclosure, the education platform is accessed on the one or more communication devices 104 through the plurality of web browsers. In an example, a user U1 surfs various mathematical training videos (let's say a differential equation lecture) on an education platform E1 on a communication device D1 (let's say a smartphone) through a web browser W1 (let's say UC Browser). In another example, a user U2 submits online science project (let's say a hydraulic power brakes) on an education platform E2 installed in a form of application on a communication device D2 (let's say a desktop computer). In yet another example, a user U3 prepares for common entrance exam on an education platform E3 installed on a communication device D3 (let's say a tablet).

The plurality of users 102 connects with the real estate and housing platform on the one or more communication devices 104 to access the plurality of real estate services. In an embodiment of the present disclosure, the real estate and housing platform is the application installed on the one or more communication devices 104. In another embodiment of the present disclosure, the real estate and housing platform is accessed on the one or more communication devices 104 through the plurality of web browsers. In an example, a user U1 surfs various apartment (let's say a studio apartment) on sale on a real estate platform R1 installed in a form of application on a communication device D1 (let's say a smartphone). In another example, a user U2 requests property seller contact details on a real estate platform R2 on a communication device D2 (let's say a desktop computer) through a web browser W2 (let's say Google Chrome). In yet another example, a user U3 uploads images of a property (let's say a penthouse) for sale on a real estate platform R3 on a communication device D3 (let's say a tablet). In yet another example, a user U4 negotiates online for rent of a bungalow on a real estate platform R4 installed on a communication device D4 (let's say a laptop).

The plurality of users 102 connects with the travel platform on the one or more communication devices 104 to access the plurality of travel services. In an embodiment of the present disclosure, the travel platform is the application installed on the one or more communication devices 104. In another embodiment of the present disclosure, the travel platform is accessed on the one or more communication devices 104 through the plurality of web browsers. In an example, a user U1 surfs various flight options to travel from California to Chicago on a travel platform T1 installed in a form of application on a communication device D1 (let's say a smartphone). In another example, a user U2 requests price quotation for fifty hotel rooms in Cleveland on a travel platform T2 on a communication device D2 (let's say a desktop computer) through a web browser W2 (let's say Safari Browser). In yet another example, a user U3 uploads images of food (let's say a Thai Food) on a travel platform T3 installed on a communication device D3 (let's say a tablet). In yet another example, a user U4 books holiday package (let's say 5 days and 6 nights) for Switzerland on a travel platform T4 on a communication device D4 (let's say a laptop) through a web browser W4 (let's say Opera Browser).

Each of the one or more communication devices 104 includes a keyboard and a set of audio sensors. In general, keyboard allows the users to enter characters and functions into the communication devices by pressing buttons, or virtual keys. In an embodiment of the present disclosure, the keyboard is an on-screen keyboard. In another embodiment of the present disclosure, the keyboard is a virtual keyboard. In yet another embodiment of the present disclosure, the keyboard is an external physical keyboard. In general, audio sensor translates sound vibrations in the air into electronic signals to a recording medium. The audio sensor enables many types of audio recording and communication purposes. In an embodiment of the present disclosure, the set of audio sensors is an inbuilt sensor of the one or more communication devices 104. In another embodiment of the present disclosure, the set of audio sensors is an external audio sensor. The set of sensors include but may not be limited to one or more microphones, geophones, hydrophones, sonars, and/or sodars. In addition, the set of audio sensors may include any combination of microphones, geophones, hydrophones, sonars, and/or sodars.

In an embodiment of the present disclosure, the plurality of users 102 accesses the plurality of contents on the one or more online platforms using the keyboard through the one or more communication devices 104. In an example, a user U1 accesses the anime in Japanese language using virtual keyboard through a communication device D1 (let's say tablet). In another example, a user U2 searches electronics item E2 (let's say a trimmer) in Mandarin language using an external keyboard through a communication device D2 (let's say a workstation). In another embodiment of the present disclosure, the plurality of users 102 accesses the plurality of contents on the one or more online platforms using the set of audio sensors through the one or more communication devices 104. In an example, a user U1 searches the Sci-Fi book in Malay language using voice command through a microphone of a communication device D1 (let's say a desktop computer). In another example, a user U2 accesses an action movie in Hindi language using voice command through a microphone of a communication device D2 (let's say a laptop).

Each of the one or more communication devices 104 includes a memory. In general, the memory includes computer-storage media in the form of volatile and/or nonvolatile memory. The memory may be removable, non-removable, or a combination thereof. Exemplary hardware devices include solid-state memory, hard drives, optical-disc drives, etc. The memory is coupled with one or more processors. In general, the one or more processor read data from various entities such as memory or I/O components. The one or more processor execute the one or more instructions which are stored in the memory. The one or more processors provide execution method for one or more instructions provided by the multi-lingual campaigning system 104.

The one or more communication devices 104 are a media device. The one or more communication devices 104 enable the plurality of users 102 to access the plurality of contents on the one or more online platforms. The one or more communication devices 104 support various multimedia contents. The plurality of users 102 accesses the plurality of contents in real-time through the one or more communication devices 104. In an embodiment of the present disclosure, the plurality of contents is a video stream. In another embodiment of the present disclosure, the plurality of contents corresponds to video on demand being accessed on the one or more communication devices 104. In yet another embodiment of the present disclosure, the plurality of contents is an audio clip. In yet another embodiment of the present disclosure, the plurality of contents corresponds to an e-commerce product. In yet another embodiment of the present disclosure, the plurality of contents is an illustration. In yet another embodiment of the present disclosure, the plurality of contents is an e-book.

The plurality of users 102 customizes a primary language preference and a secondary language preference for display of the one or more communication devices 104. In addition, the plurality of users 102 customizes the primary language preference and the secondary language preference for the one or more online platforms of the one or more communication devices 104. Further, the plurality of users 102 customizes the primary language preference and the secondary language preference for the plurality of web browsers of the one or more communication devices 104. Furthermore, the plurality of users 102 customizes the primary language preference and the secondary language preference for the keyboard of the one or more communication devices 104. Moreover, the plurality of users 102 customizes the primary language preference and the secondary language preference for the set of audio sensors of the one or more communication devices 104. Moreover, the plurality of users 102 customizes the primary language preference and the secondary language preference for the set of audio sensors of the one or more communication devices 104.

The interactive computing environment 100 includes the communication network 106. The one or more communication devices 104 are connected to the communication network 106. The communication network 106 provides a medium to the one or more communication devices 104 to connect to the multi-lingual campaigning system 112. In an embodiment of the present disclosure, the communication network 106 is an internet connection. In another embodiment of the present disclosure, the communication network 106 is a wireless mobile network. In yet another embodiment of the present disclosure, the communication network 106 is a wired network with a finite bandwidth. In yet another embodiment of the present disclosure, the communication network 106 is a combination of the wireless and the wired network for the optimum throughput of data transmission. In yet another embodiment of the present disclosure, the communication network 106 is an optical fiber high bandwidth network that enables a high data rate with negligible connection drops. The communication network 106 includes a set of channels. Each channel of the set of channels supports a finite bandwidth. Moreover, the finite bandwidth of each channel of the set of channels is based on capacity of the communication network 106. The communication network 106 connects the one or more communication devices 104 to the multi-lingual campaigning system 112 using a plurality of methods. The plurality of methods used to provide network connectivity to the one or more communication devices 104 includes 2G, 3G, 4G, 5G, Wifi and the like.

Further, each of the one or more communication devices 104 embeds a signal generator circuitry. Each of the one or more communication devices 104 embeds the signal generator circuitry to trigger a signal for communicating information between the associated systems in real time. In an embodiment of the present disclosure, the signal generator circuitry generates a signal to trigger one or more hardware components associated with each of the one or more communication devices 104. The one or more hardware components are triggered for one or more purposes. The one or more purposes include but are not limited to receive the first set of data, collect a second set of data, fetch a third set of data, analyze the first set of data, the second set of data and the third set of data, and the like. The one or more purposes include generating signal based on requirement of the multi-lingual campaigning system 112.

The interactive computing environment 100 includes the one or more publishers 108. In addition, the one or more publishers 108 correspond to one or more online platform owners for providing the plurality of contents to the plurality of users 102. Further, the one or more publishers 108 provide one or more advertisement slots. In general, advertisement slots are space, areas or a part of web pages or applications for advertising purposes. The one or more publishers 108 provide the one or more advertisement slots for the web page or the application. The one or more publishers 108 advertise products, services or businesses to the plurality of users 102 for generating revenue.

In an embodiment of the present disclosure, the one or more publishers 108 display the one or more advertisements on the corresponding advertisement slots of the one or more advertisement slots. In an embodiment of the present disclosure, the one or more advertisements are displayed for generating revenue based on number of impressions, number of clicks and number of installs taken by the plurality of users 102. In an embodiment of the present disclosure, the one or more advertisements are displayed during viewing of the plurality of contents. In an example, a user U1 encounters an advertisement while viewing one or more products on a publisher P1. In another embodiment of the present disclosure, the one or more advertisements are displayed along with the plurality of contents viewed by the plurality of users 102 on the one or more online platforms.

The interactive computing environment 100 includes the one or more advertisers 110. The one or more advertisers 110 purchase the one or more advertisement slots from the one or more publishers 108. In an embodiment of the present disclosure, the one or more advertisers 110 purchase the one or more advertisement slots to display the one or more advertisements. In an embodiment of the present disclosure, the one or more advertisers 110 generate revenue based on the number of impressions, the number of clicks and the number of installs. Further, the one or more advertisers 110 provide the one or more advertisements to the plurality of users 102 in real time. Furthermore, the one or more publishers 108 and the one or more advertisers 110 are associated with the multi-lingual campaigning system 112. In an embodiment of the present disclosure, the one or more publishers 108 and the one or more advertisers 110 are associated with the multi-lingual campaigning system 112 through the communication network 106.

The one or more advertisements are part of one or more personalized marketing campaigns run by the one or more advertisers 110. The one or more advertisements are graphical or pictorial representations of information to promote a product, an event, a service and the like. In general, advertisement is a medium for promoting a product, service, or an event. The one or more advertisements include audio advertisements, text advertisements, video advertisements, audio-video advertisements, pictorial advertisements, pop-up advertisements, hyperlinked advertisements, graphic advertisements, and the like. The one or more advertisements are presented or played to attract the plurality of users 102. The one or more advertisements are displayed or played within the one or more online platforms in order to generate revenue. The one or more advertisements are played or displayed for a specific period of time within the one or more online platforms. In addition, the one or more personalized marketing campaigns are initiated by the one or more advertisers 110. Further, the one or more advertisements are displayed on the one or more communication devices 104 in real-time. In an embodiment of the present disclosure, the one or more advertisements displayed are associated with the interests of the plurality of users 102.

The interactive computing environment 100 includes the multi-lingual campaigning system 112. The multi-lingual campaigning system 112 receives the first set of data associated with the plurality of users 102. The multi-lingual campaigning system 112 obtains the second set of data associated with the plurality of users 102. The multi-lingual campaigning system 112 fetches the third set of data associated with the one or more communication devices 104 of the plurality of users 102. The multi-lingual campaigning system 112 enables identification of the plurality of languages across the vernacular contexts of the plurality of users 102 through the first set of data, the second set of data, and the third set of data. The multi-lingual campaigning system 112 determines proficiency in the plurality of languages across the vernacular contexts of each of the plurality of users 102. The multi-lingual campaigning system 112 initiates the one or more personalized marketing campaigns. The one or more personalized marketing campaigns are adaptive and dynamic in nature.

The multi-lingual campaigning system 112 receives the first set of data associated with the plurality of users 102. The first set of data includes name data, age data, e-mail identity data, contact number data, gender data, demographic data, relationship status data, native language data, and native place data. In addition, the first set of data include but may not be limited to Geo-IP data, real-time geographical location data, past geographical location data, profession data, hobbies data, and interests data. In an embodiment of the present disclosure, the multi-lingual campaigning system 112 receives the first set of data from inputs of the plurality of users 102. In another embodiment of the present disclosure, the multi-lingual campaigning system 112 receives the first set of data from a third-party application installed on the one or more communication devices 104. In yet another embodiment of the present disclosure, the multi-lingual campaigning system 112 receives the first set of data from the one or more online platforms of the one or more communication devices 104. The first set of data is associated with personal information of the plurality of users 102. In addition, the multi-lingual campaigning system 112 receives the first set of data in the real-time.

The multi-lingual campaigning system 112 collects the second set of data associated with the plurality of users 102. The second set of data corresponds to audio data of the plurality of users 102. In addition, the second set of data is collected from the set of audio sensors. Further, the second set of data include but may not be limited to recorded speech data, real-time speech data, past voice command data, and real-time voice command data. In an embodiment of the present disclosure, the multi-lingual campaigning system 112 collects the second set of data from the set of audio sensors of the one or more communication devices 104. In another embodiment of the present disclosure, the multi-lingual campaigning system 112 collects the second set of data from the one or more online platforms of the one or more communication devices 104. In another embodiment of the present disclosure, the multi-lingual campaigning system 112 collects the second set of data from the third-party application installed in the one or more communication devices 104. In addition, the multi-lingual campaigning system 112 collects the second set of data in the real-time.

The multi-lingual campaigning system 112 fetches the third set of data associated with the one or more communication devices 104 of the plurality of users 102. In addition, the third set of data includes past typing data, real-time typing data, primary language preference data of the one or more communication devices 104, and secondary language preference data of the one or more communication devices 104. Further, the third set of data include but may not be limited to the browser language data, application language data, installed keyboard data and speech language data. In an embodiment of the present disclosure, the multi-lingual campaigning system 112 fetches the third set of data from the keyboard of the one or more communication devices 104. In another embodiment of the present disclosure, the multi-lingual campaigning system 112 fetches the third set of data from the one or more online platforms of the one or more communication devices 104. In yet another embodiment of the present disclosure, the multi-lingual campaigning system 112 fetches the third set of data from the one or more communication devices 104. In addition, the multi-lingual campaigning system 112 fetches the third set of data in the real-time.

The multi-lingual campaigning system 112 analyzes the first set of data, the second set of data, and the third set of data using one or more machine learning algorithms. In an embodiment of the present disclosure, the one or more machine learning algorithms include a decision tree algorithm and a random forest algorithm. In another embodiment of the present disclosure, the one or more machine learning algorithms include but may not be limited to prediction algorithms, deep learning algorithms, natural language processing algorithm and the like. However, the one or more machine learning algorithms are not limited to the above-mentioned algorithms. The analysis of the first set of data, the second set of data and the third set of data based on the one or more machine learning algorithms is done in real-time. In addition, the multi-lingual campaigning system 112 creates a machine learning model to perform analysis of the first set of data, the second set of data, and the third set of data. The machine learning model is trained to identify the plurality of languages across the vernacular contexts of the plurality of users 102 based on analysis of the first set of data, the second set of data, and the third set of data. In addition, the machine learning model is trained to identify a plurality of language attributes of the plurality of languages across the vernacular contexts of the plurality of users 102.

The machine learning model is trained to analyze the first set of data, the second set of data, and the third set of data. Furthermore, the machine learning model is trained to track user consumption of the plurality of contents on the one or more online platforms by the plurality of users 102 in the plurality of languages. In an embodiment of the present disclosure, the machine learning model is trained using supervised machine learning model. In another embodiment of the present disclosure, the machine learning model is trained using un-supervised machine learning model. Moreover, the machine learning model predicts conversion potential of each of the plurality of users 102. In general, the conversion potential corresponds to probability of the plurality of users 102 who may interact with the one or more advertisements. The multi-lingual campaigning system 112 creates a vernacular profile of each of the plurality of users 102 based on the analysis of the first set of data, the second set of data, and the third set of data using the one or more machine learning algorithms.

The multi-lingual campaigning system 112 enables identification of each of the plurality of languages across the vernacular contexts of the plurality of users 102 using the one or more machine learning algorithms. In an embodiment of the present disclosure, the multi-lingual campaigning system 112 identifies the plurality of languages through a combination of language preferences, keyboard text inputs, the voice command data, real-time geographical location and native place. In another embodiment of the present disclosure, the multi-lingual campaigning system 112 identifies the plurality of languages of the plurality of users 102 through the language preferences of the one or more communication devices 104. In yet another embodiment of the present disclosure, the multi-lingual campaigning system 112 identifies the plurality of languages of the plurality of users 102 through the language preferences of the one or more online platforms. In yet another embodiment of the present disclosure, the multi-lingual campaigning system 112 identifies the plurality of languages of the plurality of users 102 through the text inputs through the keyboard of the one or more communication devices 104. In yet another embodiment of the present disclosure, the multi-lingual campaigning system 112 identifies the plurality of languages of the plurality of users 102 through the voice command of the plurality of users 102 on the set of audio sensors. In yet another embodiment of the present disclosure, the multi-lingual campaigning system 112 identifies the plurality of languages of the plurality of users 102 through the real-time geographical location of the plurality of users 102. In yet another embodiment of the present disclosure, the multi-lingual campaigning system 112 identifies the plurality of languages of the plurality of users 102 through the native place of the plurality of users 102.

The multi-lingual campaigning system 112 enables identification of each of the plurality of language attributes across the vernacular contexts of the plurality of users 102 using the one or more machine learning algorithms. The plurality of language attributes includes language proficiency in the plurality of languages across the vernacular contexts of each of the plurality of users 102, and a regional dialect across the vernacular contexts of each of the plurality of users 102. In addition, the plurality of language attributes includes an accent associated with each of the plurality of users 102, frequency of the audio data, wavelength of the audio data, and amplitude of the audio data. Further, the plurality of language attributes include but may not be limited to pitch of the audio data, tone of the audio data, intensity of the audio data, speed of the audio data, and tempo of the audio data.

The multi-lingual campaigning system 112 determines the proficiency in the plurality of languages across the vernacular contexts of each of the plurality of users 102 using the one or more machine learning algorithms. In an embodiment of the present disclosure, the multi-lingual campaigning system 112 determines the proficiency in the plurality of languages by analyzing the switching of the language by each of the plurality of users 102 using the keyboard. In another embodiment of the present disclosure, the multi-lingual campaigning system 112 determines the proficiency in the plurality of languages by analyzing the switching of the language of the set of audio sensors by each of the plurality of users 102. In yet another embodiment of the present disclosure, the multi-lingual campaigning system 112 determines the proficiency in the plurality of languages from the primary and the secondary language settings in the one or more communication devices 104. In yet another embodiment of the present disclosure, the multi-lingual campaigning system 112 determines the proficiency in the plurality of languages from the analysis of the voice command data. In yet another embodiment of the present disclosure, the multi-lingual campaigning system 112 determines the proficiency in the plurality of languages from the native place. The multi-lingual campaigning system detects the accent associated with each of the plurality of users 102 based on the analysis performed on the second set of data using the one or more machine learning algorithms. In an embodiment of the present disclosure, the multi-lingual campaigning system 112 determines the accent by analyzing vowels, consonants, pitch variation, intonation, pronunciations, and phonological variations of the second set of data. The multi-lingual campaigning system creates the vernacular profile of each of the plurality of users 102 based on the analysis of the first set of data, the second set of data, and the third set of data using the one or more machine learning algorithms. In addition, the plurality of users 102 is segmented in one or more segments based on the vernacular profile and one or more patterns. The multi-lingual campaigning system enables segmentation of the plurality of users 102 in the one or more segments based on the one or more patterns of the plurality of languages and the plurality of language attributes. In addition, the plurality of users 102 is segmented in the one or more segments in real-time. Further, the one or more patterns include language accent patterns, language proficiency patterns, frequency patterns, wavelength patterns, amplitude patterns, pitch patterns, tone patterns, intensity patterns, and tempo patterns. Furthermore, the segmentation of the plurality of users 102 in the one or more segments may be based on one or more parameters. Moreover, the one or more parameters include culture, religion, beliefs, the vernacular profile, geological location, demography, appography, and the like.

In an embodiment of the present disclosure, the multi-lingual campaigning system 112 initiates the segmentation of the plurality of users 102 based on the vernacular profile. In another embodiment of the present disclosure, the multi-lingual campaigning system 112 initiates the segmentation of the plurality of users 102 based on the culture. In yet another embodiment of the present disclosure, the multi-lingual campaigning system 112 initiates the segmentation of the plurality of users 102 based on the religion. In yet another embodiment of the present disclosure, the multi-lingual campaigning system 112 initiates the segmentation of the plurality of users 102 based on the geological location. In yet another embodiment of the present disclosure, the multi-lingual campaigning system 112 initiates the segmentation of the plurality of users 102 based on the demography. In yet another embodiment of the present disclosure, the multi-lingual campaigning system 112 initiates the segmentation of the plurality of users 102 based on the appography.

The multi-lingual campaigning system 112 triggers initialization of the one or more personalized marketing campaigns for the one or more segments based on the plurality of languages and the plurality of language attributes across the vernacular contexts. In addition, the one or more personalized marketing campaigns are initiated based on the vernacular profile of the plurality of users 102 of the one or more segments. The one or more personalized marketing campaigns are initiated for the one or more segments by the one or more advertisers 110. Further, the one or more advertisers 110 purchases the one or more advertisement slots from the one or more online platforms. In an embodiment of the present disclosure, the one or more advertisers 110 purchases the one or more advertisement slots to display the one or more advertisements on the corresponding advertisement slots.

The one or more personalized marketing campaigns are organized, strategized efforts for marketing to the plurality of users 102. The one or more personalized marketing campaigns reach the plurality of users 102 in a plurality of channels. The plurality of channels include but may not be limited to mobile channels, email channels, desktop channels, social channels, remarketing channels, server channels, and the like. However, the plurality of channels are not limited to the above-mentioned channels. The one or more personalized marketing campaigns may include an advertiser defined parameters. The advertiser defined parameters include minimum spend, discounts, campaign duration, campaign relevancy, campaign location, a customer's patronage of the online platform, user interaction, and the like. However, the advertiser defined parameters are not limited to the above-mentioned parameters.

The multi-lingual campaigning system 112 dynamically displays the one or more advertisements associated with the one or more personalized marketing campaigns for the one or more segments in real-time. In addition, the one or more advertisements are displayed to each of the plurality of users 102 on the one or more communication devices 104 based on the one or more patterns, and the vernacular profile. Further, each of the one or more advertisements adapts a plurality of characteristics according to the vernacular profile, the plurality of languages, and the plurality of language attributes. Furthermore, the plurality of characteristics includes the accent of audio of the one or more advertisements, colors used in the one or more advertisements, and costumes utilized in the one or more advertisements. Moreover, the plurality of characteristics includes phrases utilized in the one or more advertisements, brand ambassador of the one or more advertisements, theme of the one or more advertisements, and the like.

In an embodiment of the present disclosure, the one or more advertisements are displayed on the one or more communication devices 104 in the form of flash messages. In another embodiment of the present disclosure, the one or more advertisements are displayed on the one or more communication devices 104 in the form of text messages. In yet another embodiment of the present disclosure, the one or more advertisements are displayed on the one or more communication devices 104 in the form of telephonic calls. In yet another embodiment of the present disclosure, the one or more advertisements are displayed on the one or more communication devices 104 in the form of multimedia messages. In yet another embodiment of the present disclosure, the one or more advertisements are displayed on the one or more online platforms in the form of notification. In yet another embodiment of the present disclosure, the one or more advertisements are displayed on the one or more communication devices 104 as Google Ads. The one or more advertisements are displayed on the one or more communication devices 104 in real-time. In an embodiment of the present disclosure, the one or more advertisements displayed are associated with the interests of the plurality of users 102. In addition, the one or more advertisements include text advertisements, video advertisements, audio advertisements, audio-video advertisements, pictorial advertisements, and the like.

The multi-lingual campaigning system 112 dynamically modulates the audio of the one or more advertisements associated with the one or more personalized marketing campaigns based on the accent of each of the plurality of users. The multi-lingual campaigning system 112 recommends the one or more advertisements for based on the vernacular profile of each of the plurality of users 102. In addition, the multi-lingual campaigning system 112 recommends the one or more advertisements for the one or more online platforms based on the plurality of languages, and the plurality of language attributes of the plurality of users 102.

In an example, a user U1 accesses an online platform P1 (Let's say a Fintech Platform) on a webpage W1 using a communication device D1 (Let's say a desktop). In addition, the multi-lingual campaigning system 112 receives a set of data associated with the user U1 and the communication device D1. The set of data includes demographic information, native language, native place, geographical location, interests, speech data, voice command data, typing data, and language preference data. Further, the multi-lingual campaigning system 112 analyses the set of data associated with the user U1. Furthermore, the multi-lingual campaigning system 112 identifies languages, language attributes, fluency in the languages, and accent of the languages associated with the user U1. Moreover, the multi-lingual campaigning system 112 creates the vernacular profile of the user U1 based on the languages, the language attributes, the fluency in the languages, and the accent of the languages. Also, the multi-lingual campaigning system 112 puts the vernacular profile of the user U1 in an optimal segment from the one or more segments based on the one or more patterns of the languages, the language attributes, the native place, the native language, the fluency in the languages, and the accent of the languages. Also, the multi-lingual campaigning system 112 initiates a relevant advertisement campaign from the one or more personalized marketing campaigns for the optimal segment for the user U1. Also, the multi-lingual campaigning system 112 identifies that the user U1 is fluent in English. Also, the multi-lingual campaigning system 112 identifies that the user U1 has a Scottish accent. Also, the multi-lingual campaigning system 112 identifies that the user U1 is a native of Scotland. Also, the multi-lingual campaigning system 112 selects the relevant advertisement campaign from the one or more personalized marketing campaigns based on English, Scottish Accent and Scotland. Also, the multi-lingual campaigning system 112 display a video advertisement associated with the relevant advertisement campaign on the online platform P1. Also, the multi-lingual campaigning system 112 modulates audio of the video advertisement according to the Scottish accent. Also, the multi-lingual campaigning system 112 selects the video advertisement having Scottish theme. The video advertisement is relevant to Scottish Culture.

In another example, a user U2 accesses an online platform P2 (Let's say an OTT Platform) using a communication device D2 (Let's say a tablet). In addition, the multi-lingual campaigning system 112 receives a set of data associated with the user U2 and the communication device D2. The set of data includes demographic information, native language, native place, geographical location, interests, speech data, voice command data, typing data, and language preference data. Further, the multi-lingual campaigning system 112 analyses the set of data associated with the user U2. Furthermore, the multi-lingual campaigning system 112 identifies that the user U2 is fluent in Hindi. Moreover, the multi-lingual campaigning system 112 identifies that the user U2 has an Awadhi accent. Also, the multi-lingual campaigning system 112 identifies that the user U2 is a native of Uttar Pradesh State of India. Also, the multi-lingual campaigning system 112 selects a relevant advertisement campaign from the one or more personalized marketing campaigns based on Hindi, Awadhi Accent and Uttar Pradesh. Also, the multi-lingual campaigning system 112 recommends a brand ambassador suitable for the relevant advertisement campaign based on popularity for the user U2. Also, the multi-lingual campaigning system 112 display a video advertisement having the brand ambassador on the online platform P2. Also, the multi-lingual campaigning system 112 modulates audio of the brand ambassador in the video advertisement according to the Awadhi accent. Also, the multi-lingual campaigning system 112 selects the video advertisement having Awadhi theme. The video advertisement is relevant to Awadhi Culture.

The interactive computing environment 100 includes the server 114 and the database 116. The multi-lingual campaigning system 112 is associated with the server 114. In general, server is a computer program or device that provides functionality for other programs or devices. The server 114 provides various functionalities, such as sharing data or resources among multiple clients, or performing computation for a client. However, those skilled in the art would appreciate that the multi-lingual campaigning system 112 is connected to more number of servers. Furthermore, it may be noted that the server 114 includes the database 116. However, those skilled in the art would appreciate that more number of the servers include more numbers of database.

In an embodiment of the present disclosure, the multi-lingual campaigning system 112 is located in the server 114. In another embodiment of the present disclosure, the multi-lingual campaigning system 112 is connected with the server 114. In yet another embodiment of the present disclosure, the multi-lingual campaigning system 112 is a part of the server 114. The server 114 handles each operation and task performed by the multi-lingual campaigning system 112. The server 114 stores one or more instructions for performing the various operations of the multi-lingual campaigning system 112. The server 114 is located remotely from the one or more online platforms. The server 114 is associated with an administrator. In addition, the administrator manages the different components in the multi-lingual campaigning system 112. The administrator coordinates the activities of the components involved in the multi-lingual campaigning system 112. The administrator is any person or individual who monitors the working of the multi-lingual campaigning system 112 and the server 114 in real-time. The administrator monitors the working of the multi-lingual campaigning system 112 and the server 114 through a communication device. The communication device includes the laptop, the desktop computer, the tablet, a personal digital assistant and the like.

The database 116 stores different sets of information associated with various components of the multi-lingual campaigning system 112. In addition, the database 116 is used to hold general information and specialized data, such as the first set of data of the plurality of users 102, the second set of data of the plurality of users 102, and the third set of data of the one or more communication devices 104. The database 116 stores data of the one or more publishers 108, information of the one or more advertisers 110, the vernacular profile of each of the plurality of users 102, and the like. The database 116 organizes the data using model such as relational models or hierarchical models. Further, the database 116 store data provided by the administrator.

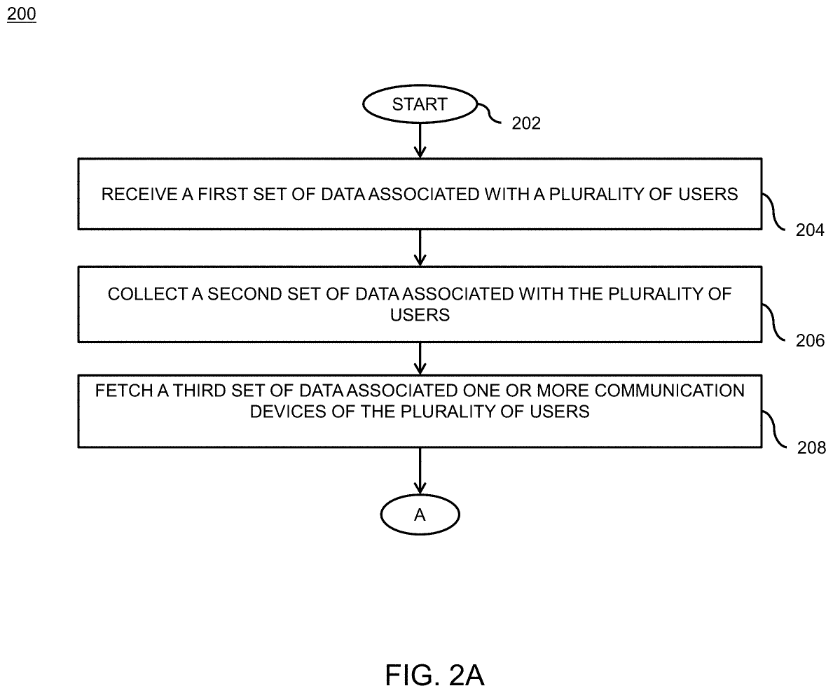

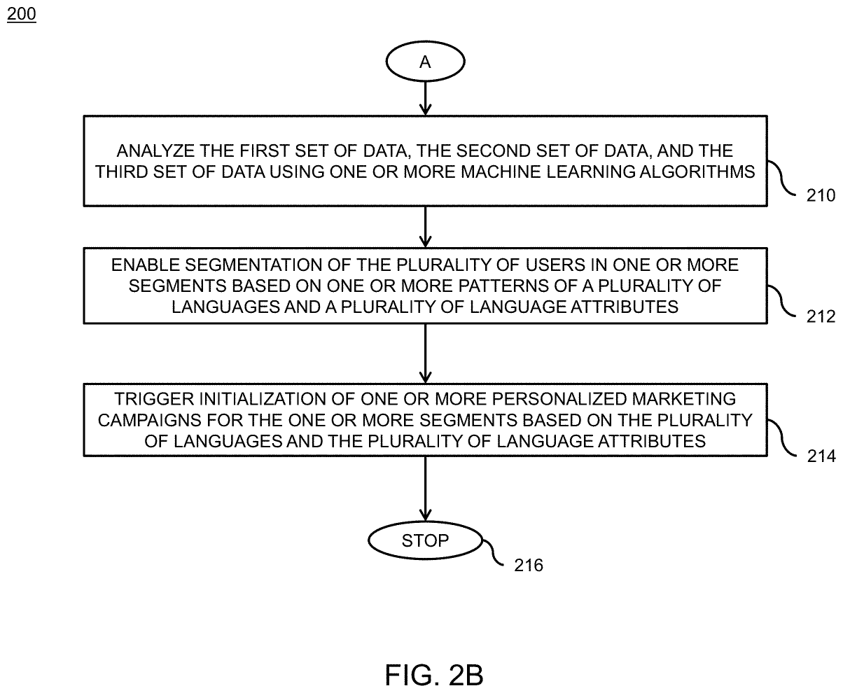

FIGS. 2A and 2B illustrate a flowchart 200 of a method for adopting the user learnings across the vernacular contexts, in accordance with various embodiments of the present disclosure. It may be noted that in order to explain the method of the flowchart 200, references will be made to the elements explained in FIG. 1. The flow chart 200 starts at step 202. At step 204, the multi-lingual campaigning system 112 receives the first set of data associated with the plurality of users 102. At step 206, the multi-lingual campaigning system 112 collects the second set of data associated with the plurality of users 102. At step 208, the multi-lingual campaigning system 112 fetches the third set of data associated with the one or more communication devices 104 of the plurality of users 102. At step 210, the multi-lingual campaigning system 112 analyzes the first set of data, the second set of data, and the third set of data using the one or more machine learning algorithms. At step 212, the multi-lingual campaigning system 112 enables segmentation of the plurality of users 102 in the one or more segments based on the one or more patterns of the plurality of languages and the plurality of language attributes. At step 214, the multi-lingual campaigning system 112 triggers initialization of the one or more personalized marketing campaigns for the one or more segments based on the plurality of languages and the plurality of language attributes.

The flow chart 200 terminates at step 216. It may be noted that the flowchart 200 is explained to have above stated process steps; however, those skilled in the art would appreciate that the flowchart 200 may have more/less number of process steps which may enable all the above stated embodiments of the present disclosure.

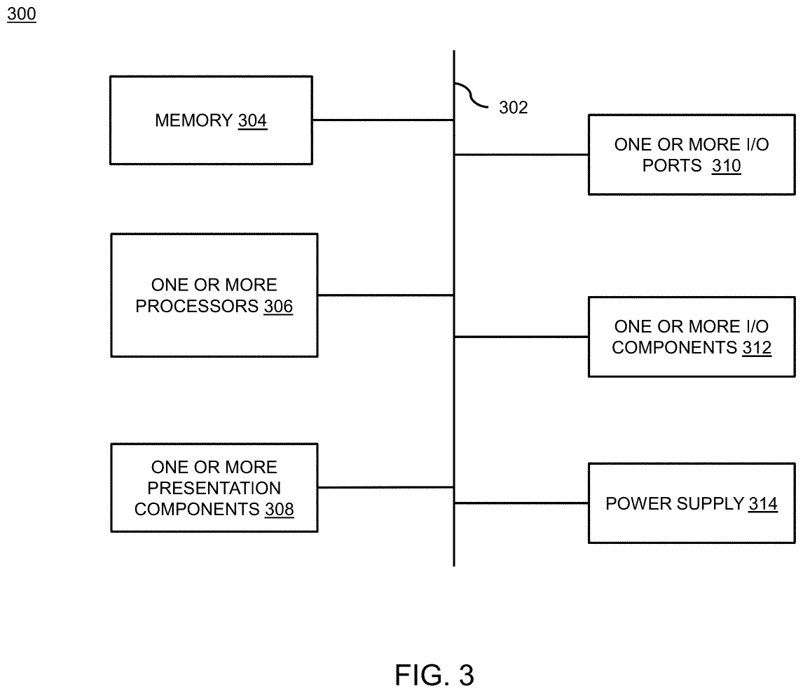

FIG. 3 illustrates a block diagram of a computing device 300, in accordance with various embodiments of the present disclosure. The computing device 300 includes a bus 302 that directly or indirectly couples the following devices: a memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data.

The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes one or more processors that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for adopting user learnings across vernacular contexts, the computer-implemented method comprising:
receiving, at a multi-lingual campaigning system with a processor, a first set of data associated with a plurality of users;
collecting, at the multi-lingual campaigning system with the processor, a second set of data associated with the plurality of users;
fetching, at the multi-lingual campaigning system with the processor, a third set of data associated with one or more communication devices of the plurality of users;
analyzing, at the multi-lingual campaigning system with the processor, the first set of data, the second set of data, and the third set of data using one or more machine learning algorithms, wherein the analysis is performed based on training of a machine learning model, wherein the analysis is performed for identifying a plurality of languages across the vernacular contexts of the plurality of users, wherein the analysis is performed for identifying a plurality of language attributes of the plurality of languages across the vernacular contexts of the plurality of users, wherein the analysis is performed in real time;
enabling, at the multi-lingual campaigning system with the processor, segmentation of the plurality of users in one or more segments based on one or more patterns of the plurality of languages and the plurality of language attributes, wherein the plurality of users is segmented in the one or more segments in real-time; and
triggering, at the multi-lingual campaigning system with the processor, initialization of one or more personalized marketing campaigns for the one or more segments based on the plurality of languages and the plurality of language attributes across the vernacular contexts of the plurality of users, wherein the one or more personalized marketing campaigns are initiated based on the one or more patterns of the one or more segments, wherein the one or more personalized marketing campaigns are initiated in real-time.

2. The computer-implemented method as recited in claim 1, wherein the first set of data comprising name data, age data, e-mail identity data, contact number data, gender data, demographic data, relationship status data, native language data, native place data, Geo-IP data, real-time geographical location data, past geographical location data, profession data, hobbies data, and interests data.

3. The computer-implemented method as recited in claim 1, wherein the second set of data corresponds to audio data of the plurality of users, wherein the second set of data is collected from a set of audio sensors, wherein the second set of data comprising recorded speech data, real-time speech data, past voice command data, and real-time voice command data.

4. The computer-implemented method as recited in claim 1, wherein the third set of data comprising past typing data, real-time typing data, primary language preference data of the one or more communication devices, secondary language preference data of the one or more communication devices, browser language data, application language data, installed keyboard data and speech language data.

5. The computer-implemented method as recited in claim 1, further comprising creating, at the multi-lingual campaigning system with the processor, a vernacular profile of each of the plurality of users based on the analysis of the first set of data, the second set of data, and the third set of data using the one or more machine learning algorithms, wherein the plurality of users is segmented in the one or more segments based on the vernacular profile and the one or more patterns.

6. The computer-implemented method as recited in claim 1, wherein the plurality of language attributes comprising language proficiency in the plurality of languages across the vernacular contexts of each of the plurality of users, a regional dialect across the vernacular contexts of each of the plurality of users, an accent associated with each of the plurality of users, frequency of the audio data, wavelength of the audio data, amplitude of the audio data, pitch of the audio data, tone of the audio data, intensity of the audio data, speed of the audio data, and tempo of the audio data.

7. The computer-implemented method as recited in claim 1, further comprising detecting, at the multi-lingual campaigning system with the processor, the accent associated with each of the plurality of users based on the analysis performed on the second set of data using the one or more machine learning algorithms.

8. The computer-implemented method as recited in claim 1, further comprising dynamically displaying, at the multi-lingual campaigning system with the processor, one or more advertisements associated with the one or more personalized marketing campaigns for the one or more segments in real-time, wherein the one or more advertisements are displayed to each of the plurality of users on the one or more communication devices based on the one or more patterns, and the vernacular profile, wherein each of the one or more advertisements adapts a plurality of characteristics according to the vernacular profile, the plurality of languages, and the plurality of language attributes, wherein the plurality of characteristics comprising the accent of audio of the one or more advertisements, colors used in the one or more advertisements, costumes utilized in the one or more advertisements, phrases utilized in the one or more advertisements, brand ambassador of the one or more advertisements, and theme of the one or more advertisements.

9. The computer-implemented method as recited in claim 1, further comprising dynamically modulating, at the multi-lingual campaigning system with the processor, the audio of the one or more advertisements associated with the one or more personalized marketing campaigns based on the accent of each of the plurality of users.

10. A computer system comprising:
one or more processors; and
a memory coupled to the one or more processors, the memory for storing instructions which, when executed by the one or more processors, cause the one or more processors to perform a method for adopting user learnings across vernacular contexts, the method comprising:
receiving, at a multi-lingual campaigning system, a first set of data associated with a plurality of users;
collecting, at the multi-lingual campaigning system, a second set of data associated with the plurality of users;
fetching, at the multi-lingual campaigning system, a third set of data associated with one or more communication devices of the plurality of users;
analyzing, at the multi-lingual campaigning system, the first set of data, the second set of data, and the third set of data using one or more machine learning algorithms, wherein the analysis is performed based on training of a machine learning model, wherein the analysis is performed for identifying a plurality of languages across the vernacular contexts of the plurality of users, wherein the analysis is performed for identifying a plurality of language attributes of the plurality of languages across the vernacular contexts of the plurality of users, wherein the analysis is performed in real time;
enabling, at the multi-lingual campaigning system, segmentation of the plurality of users in one or more segments based on one or more patterns of the plurality of languages and the plurality of language attributes, wherein the plurality of users is segmented in the one or more segments in real-time; and
triggering, at the multi-lingual campaigning system, initialization of one or more personalized marketing campaigns for the one or more segments based on the plurality of languages and the plurality of language attributes across the vernacular contexts of the plurality of users, wherein the one or more personalized marketing campaigns are initiated based on the one or more patterns of the one or more segments, wherein the one or more personalized marketing campaigns are initiated in real-time.

11. The computer system as recited in claim 10, wherein the first set of data comprising name data, age data, e-mail identity data, contact number data, gender data, demographic data, relationship status data, native language data, native place data, Geo-IP data, real-time geographical location data, past geographical location data, profession data, hobbies data, and interests data.

12. The computer system as recited in claim 10, wherein the second set of data corresponds to audio data of the plurality of users, wherein the second set of data is collected from a set of audio sensors, wherein the second set of data comprising recorded speech data, real-time speech data, past voice command data, and real-time voice command data.

13. The computer system as recited in claim 10, wherein the third set of data comprising past typing data, real-time typing data, primary language preference data of the one or more communication devices, secondary language preference data of the one or more communication devices, browser language data, application language data, installed keyboard data and speech language data.

14. The computer system as recited in claim 10, further comprising creating, at the multi-lingual campaigning system, a vernacular profile of each of the plurality of users based on the analysis of the first set of data, the second set of data, and the third set of data using the one or more machine learning algorithms, wherein the plurality of users is segmented in the one or more segments based on the vernacular profile and the one or more patterns.

15. The computer system as recited in claim 10, wherein the plurality of language attributes comprising language proficiency in the plurality of languages across the vernacular contexts of each of the plurality of users, a regional dialect across the vernacular contexts of each of the plurality of users, an accent associated with each of the plurality of users, frequency of the audio data, wavelength of the audio data, amplitude of the audio data, pitch of the audio data, tone of the audio data, intensity of the audio data, speed of the audio data, and tempo of the audio data.

16. The computer system as recited in claim 10, further comprising detecting, at the multi-lingual campaigning system, the accent associated with each of the plurality of users based on the analysis performed on the second set of data using the one or more machine learning algorithms.

17. The computer system as recited in claim 10, further comprising dynamically displaying, at the multi-lingual campaigning system, one or more advertisements associated with the one or more personalized marketing campaigns for the one or more segments in real-time, wherein the one or more advertisements are displayed to each of the plurality of users on the one or more communication devices based on the one or more patterns, and the vernacular profile, wherein each of the one or more advertisements adapts a plurality of characteristics according to the vernacular profile, the plurality of languages, and the plurality of language attributes, wherein the plurality of characteristics comprising the accent of audio of the one or more advertisements, colors used in the one or more advertisements, costumes utilized in the one or more advertisements, phrases utilized in the one or more advertisements, brand ambassador of the one or more advertisements, and theme of the one or more advertisements.

18. The computer system as recited in claim 10, further comprising dynamically modulating, at the multi-lingual campaigning system, the audio of the one or more advertisements associated with the one or more personalized marketing campaigns based on the accent of each of the plurality of users.

19. A non-transitory computer-readable storage medium encoding computer executable instructions that, when executed by at least one processor, performs a method for adopting user learnings across vernacular contexts, the method comprising:
receiving, at a computing device, a first set of data associated with a plurality of users;
collecting, at the computing device, a second set of data associated with the plurality of users;
fetching, at the computing device, a third set of data associated with one or more communication devices of the plurality of users;
analyzing, at the computing device, the first set of data, the second set of data, and the third set of data using one or more machine learning algorithms, wherein the analysis is performed based on training of a machine learning model, wherein the analysis is performed for identifying a plurality of languages across the vernacular contexts of the plurality of users, wherein the analysis is performed for identifying a plurality of language attributes of the plurality of languages across the vernacular contexts of the plurality of users, wherein the analysis is performed in real time;
enabling, at the computing device, segmentation of the plurality of users in one or more segments based on one or more patterns of the plurality of languages and the plurality of language attributes, wherein the plurality of users is segmented in the one or more segments in real-time; and
triggering, at the computing device, initialization of one or more personalized marketing campaigns for the one or more segments based on the plurality of languages and the plurality of language attributes across the vernacular contexts of the plurality of users, wherein the one or more personalized marketing campaigns are initiated based on the one or more patterns of the one or more segments, wherein the one or more personalized marketing campaigns are initiated in real-time.
